(19) United States
(12) Patent Application Publication
(10) Pub. No.: US 2024/0119792 A1
(43) Pub. Date: Apr. 11, 2024

(54) Wagerer Directed Donee Donation Defined By Bookmaker Donor

(71) Applicant: EDATANETWORKS INC., Edmonton (CA)

(72) Inventors: Terrance Patrick TIETZEN, Edmonton (CA); Matthew Arnold Macpherson BATES, Edmonton (CA)

(21) Appl. No.: 17/963,295

(22) Filed: Oct. 11, 2022

Related U.S. Application Data
(60) Provisional application No. 63/256,976, filed on Oct. 18, 2021.

(51) Int. Cl. G07F 17/32

(52) U.S. Cl. CPC G07F 17/3244

(57) ABSTRACT

If a wagerer places a wager with a booking entity and if the possible outcome actually occurs such that the wagerer wins the wager, and if the possible outcome actually occurred at a time when the probability of the possible outcome actually occurring as set by the booking entity did not exceed a predetermined winning odds threshold, then the booking entity makes a donation to an affinity entity selected by the wagerer, where the donation is an amount derived using a currency amount of the wager, and at least one of the probability of the outcome actually occurring at the time when the outcome actually occurred and the predetermined winning odds threshold.

### CROSS REFERENCE TO RELATED APPLICATIONS

This US Utility Patent application claims priority to U.S. Provisional Application Ser. No. 63/256,976, titled “WAGERER DIRECTED DONEE DONATION DEFINED BY BOOKMAKER DONOR”, filed on Oct. 10, 2021, which is incorporated herein by reference. This US Utility Patent Application is related to (i) U.S. patent application Ser. No. 16/466,728, titled “BLOCKCHAIN TRACKING AND MANAGING OF A TRANSACTION INCENTED BY A MERCHANT DONATION TO A CONSUMER AFFINITY”, filed on Jun. 20, 2019, published as US Patent Application Publication Number US 2019/0392489 on Dec. 26, 2019, which claims priority to Provisional application Ser. No. 62/688,814, filed on Jun. 22, 2018; (ii) U.S. Pat. No. 11,010,787, titled “Linking a transaction between a merchant and a resident of the same vicinity to the resident viewing the merchant broadcast advertisement”, filed on Aug. 1, 2018; and (iii) U.S. Pat. No. 11,068,923, titled “System for loyalty program”, filed on Sep. 18, 2015, the contents of which are each fully incorporated herein by reference.

### FIELD

Implementations described herein generally relate to an automated method of incenting a wagerer to wager on a possible outcome in a game of skill, a game of chance, or a game of a combination of skill and chance by way of an incentive to the wagerer by a booking entity, where the wagerer is incented by directing a donation to donee, upon the occurrence of the possible outcome, and where the donor of the donation is the booking entity who defines the donation.

### BACKGROUND

The use of web enabled computing devices by wagerers to place wagers with online booking entities is a growing and ubiquitous factor in online gaming, additionally the use of loyalty card or identifier by wagerers is a growing factor in in-person gaming. This growth may be attributed, at least in part, to a court reversal of a prior US Government ban on state authorization of sports betting. A consequence of this reversal is that wagerers search for booking entities to place wagers on team competitions including horse racing, dog racing, basketball, football, baseball, hockey, soccer, jai-alai, golf, boxing, rugby, cricket, auto racing, bicycle racing, tennis chess, Olympic competitions, and political (Dems vs. Reps) or entertainment competitive events, etc.

Wagerers also search for booking entities to place wagers on non-team competitions where the wagerer makes wagers against the booking entity, including but not limited to poker, blackjack, craps, roulette, etc. Probabilities of the wagerer winning a wager in such non-team competition may involve the use of a pseudo random number generator to simulate an actual, in-person non-team competition.

Booking entities compete for wagers from wagerers who wish to place wagers. One such technique by which booking entities compete for wagers who wish to place wagerers is the setting of the probability that a wagerer's wager will win the wager. This probability may be referred to as the betting odds which represent the probability of an event happening and enable the working out of how much money to be won by the wagerer when the wager is won. The betting odds may also reveal how much the booking entity is assessing to accept a wager from a wagerer. This assessment may be referred to as “juice”, “cut”, “vigorish”, or “vig”. Moreover, betting odds can be influenced by more than the factors actually relevant to the outcome of the event. The booking entity may manipulate the betting odds to incentivize wagers on a certain side, and the sum of the probabilities for a single event can surpass 100 percent because the booking entity may choose to take a cut that is incorporated directly into the betting odds.

As an example, with betting odds of 4/1, for every One Dollar ($1 US) wagered by a wagerer, Four Dollars ($4 US) will be won by the wagerer for a win of the wager. Stated otherwise, there is a twenty five percent (25%) chance of the wagerer winning the wager, calculated by 1/(4+1)=0.25. If, however, a booking entity incented the wagerer by an offer of betting odds of 4.2/1, then the wagerer may decide to place a wager with the booking entity who is willing to offer the wagerer more favorable betting odds for placement of the wager.

While favorable betting odds may be a competitive tool used by book entities to compete against each other for wagerers to place wagers, there is a need in the relevant arts for systems and methods that enable a booking entity to better competitively incent a wagerer to place a wager with the booking entity.

### SUMMARY

Implementations described herein relate to computer and server implemented methods for a wagerer to place a wager on a competition with an booking entity using at least one of an application executing on a computing device, and a mobile application executing on a web enabled mobile computing device, where the wagerer is incented to place the wager by a booking entity where, upon the wagerer winning the wager, the booking entity makes a defined donation to an affinity entity selected by the wagerer

Implementations described herein relate to one or more queries, including: (i) a wagerer places a bet with a booking entity (e.g., makes a wager with a house who ‘makes book’) on a possible outcome in a game of skill, a game of chance, or a game of a combination of skill and chance; (ii) and if the possible outcome actually occurs such that the wagerer wins the bet (e.g., the wager is won); (iii) and if the possible outcome actually occurred at a time when the probability of the possible outcome actually occurring as set by the booking entity did not exceed a predetermined winning odds threshold, then the booking entity makes a donation of an amount derived using a currency amount of the bet wagered by the wagerer and a factor that is at least one of the probability of the outcome actually occurring at the time when the outcome actually occurred, and the predetermined winning odds threshold.

In variations of the foregoing implementations, the game can be a contest that can be won by only one of plurality of contestants each having a geographic location, the bet placed by the wagerer with the booking entity can be that one contestant will win the contest, the wagerer may have designated a particular affinity entity having a geographic location, and the booking entity will then make the donation to the affinity entity designate by the wagerer only if a distance between the geographic location of the affinity entity designated by the wagerer and the geographic location of the one contestant does not exceed a predetermined travel threshold. In such variations, the predetermined travel threshold can be derived using a web mapping platform using a navigation algorithm, the geographic location of the affinity designed by the wagerer, the geographic location of the one of the two teams upon which the bet was placed by the wagerer; and one or more travel modes used by the navigation algorithm.

In further variations of the foregoing implementations, the game can be a contest that can be won by only one of a first team and a second team, the bet placed by the wagerer with the booking entity is that the first team will win the contest, at the time when the possible outcome actually occurred, there was a number of positive points for a spread bet that the first team would win the contest as set by the booking entity, and the wagerer won the bet only when the first team won the contest by a number of points greater than the positive points for the spread bet.

In still further variations of the foregoing implementations, the game can be a contest that can be won by only one of a first team and a second team, the bet placed by the wagerer with the booking entity is that the second team will win the contest, at the time when the possible outcome actually occurred, there was a number of positive points for a spread bet that the first team would win the contest as set by the booking entity, and the wagerer won the bet only when the second team lost the game to the first team by less than the number of positive points for the spread bet that the first team would win the contest.

Other implementations described herein relate to one or more queries, including: (i) if a wagerer places a bet with a booking entity on a possible outcome in a game of skill, a game of chance, or a game of a combination of skill and chance, (ii) and if the possible outcome does not actually occur such that the wagerer losses the bet, (iii) and if, at the time when the possible outcome did not actually occur, a difference in the odds between the possible outcome actually occurring as set by the booking entity and the outcome that actually did occur as set by the booking entity was less than a predetermined losing odds threshold, then the booking entity makes a donation of an amount derived using a currency amount of the bet and a factor that includes at least one of the difference in the odds between the possible outcome actually occurring and the outcome that actually did occur and the predetermined losing odds threshold.

Still further variations on the foregoing implementations include deriving a donation to be made by the booking entity to the affinity entity designated by the wagerer using a booking entity donation business rule. By way of example, and not by way of limitation, the booking entity donation business rule may include the booking entity making one or more choices, including: (i) a choice to offer the incentive of the booking entity to the affinity entity designated by the wagerer for a predetermined time period, (ii) a choice of a predetermined percentage of the amount of the wagerer's winnings that the booking entity will donate to the affinity entity designated by the wagerer, (iii) a choice of a maximum amount that is donated to the affinity entity designated by the wagerer, (iv) a choice of the predetermined winning odds threshold, (v) a choice of the predetermined losing odds threshold, and (vi) a choice of the predetermined travel threshold.

It will be appreciated that the foregoing summary merely describes exemplary, illustrative and non-limiting implementations.

### BRIEF DESCRIPTION OF THE DRAWINGS

Non-limiting and non-exhaustive aspects are described with reference to the following figures, wherein like reference numerals refer to like parts throughout the various figures unless otherwise specified.

FIG. 1 is a schematic illustrating an exemplary networked environment in which a wagerer places a wager with a booking entity on a possible outcome in a game of skill, a game of chance, or a game of a combination of skill and chance, and if the possible outcome actually occurs such that the wagerer wins the wager, and if the possible outcome actually occurred at a time when the probability of the possible outcome actually occurring as set by the booking entity did not exceed a predetermined winning odds threshold, then the booking entity make a donation to an affinity entity selected by the wagerer;

FIG. 2 is a flowchart illustrating an exemplary process, which can be performed in the environment of FIG. 1, that allows a wagerer to place a wager with a booking entity on a possible outcome in a game of skill, a game of chance, or a game of a combination of skill and chance, and if the possible outcome actually occurs such that the wagerer wins the wager, and if the possible outcome actually occurred at a time when the probability of the possible outcome actually occurring as set by the booking entity did not exceed a predetermined winning odds threshold, then the booking entity makes a donation to an affinity entity selected by the wagerer;

FIG. 3a illustrates a screen shot characterizing an exemplary user interface for a wagerer to designate one or more affinity entities to whom donations by a booking entity are to be made incident to the process of FIG. 2, where when the possible outcome actually occurs such that the wagerer wins the bet, then the booking entity makes a donation to the one or more affinity entities designed by the wagerer;

FIGS. 3b-5b illustrate respective screen shots characterizing successive exemplary user interfaces by which a wagerer can place a wager with a booking entity incident to the process of FIG. 2, where when the possible outcome actually occurs such that the wagerer wins the bet, then the booking entity makes a donation to the affinity entity(ies) selected by the wagerer;

FIG. 6 illustrate a screen shot characterizing a user interfaces by which a wagerer can place a wager with a booking entity by clicking on a “YES” icon to initiate the process of FIG. 2 by which, when the possible outcome actually occurs such that the wagerer wins the bet, then the booking entity makes a payout for the winning wager to the wagerer and also makes the displayed donation to the affinity entity(ies) selected by the wagerer; and

FIGS. 7-11 are flowcharts of respective exemplary processes according to implementations described herein, each of which can be performed in the environment of FIG. 1, that allows a wagerer to place a wager, which wager can be placed using the user interfaces such as are seen in FIGS. 3b-5b, where the wager is placed with a booking entity on a possible outcome in a game of skill, a game of chance, or a game of a combination of skill and chance, and if the possible outcome actually occurs such that the wagerer wins the wager, and if the possible outcome actually occurred at a time when the probability of the possible outcome actually occurring as set by the booking entity did not exceed a predetermined winning odds threshold, then the booking entity makes a donation to one or more affinity entities that will be, or that already had been, designated by the wagerer by way of a user interface such as is seen in FIG. 3a.

Implementations will become more apparent from the detailed description set forth below when taken in conjunction with the drawings.

### DETAILED DESCRIPTION

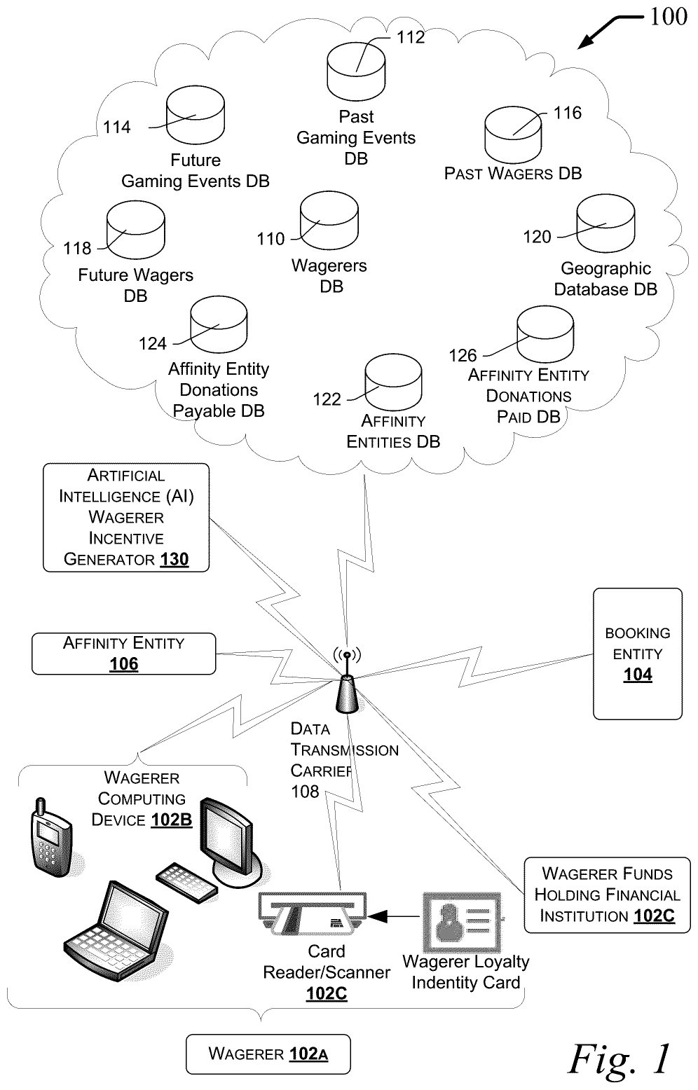

Referring now to FIG. 1, which is provided as an illustrative example only, there is depicted an environment 100 in which a wagerer 102A uses an application executing on a wagerer computing device 102B or uses a wagerer loyalty identity card in a Card Reader/Scanner 102C to communicate via a data transmission carrier 108 with a booking entity 104, a wagerer funds holding financial institution 102c, and an affinity entity 106, where each of the foregoing is in communication, via data transmission carrier 108, with various network accessible resources. These network accessible resources include a wagerers data base 110, a past gaming events database 112, a future gaming events database 114, a past wagers database 116, a future wagers database 118, a geographic database 120, an affinity entities database 122, an affinity entity donations payable database 124, and an affinity entity donations paid database 126. These network accessible resources can be included in one or more server farms and each can be one or more of a plurality of servers.

In the environment 100, wagerer 102A places a wager (e.g., a bet) with booking entity 104 on a possible outcome in a game of skill, a game of chance, or a game of a combination of skill and chance. If the possible outcome actually occurs such that wagerer 102A wins the wager, and if the possible outcome actually occurred at a time when the probability of the possible outcome actually occurring as set by booking entity 104 did not exceed a predetermined winning odds threshold, then booking entity 104 make a donation to affinity entity 106 who had been selected by wagerer 102A. By way of example, and not by way of limitation, booking entity 104 may set the predetermined winning odds threshold at 25 percent, that is, betting odds of 4 to 1. As such, if at a time when wagerer 102A won the wager, the probability that wagerer 102A would win the wager was not greater than 25 percent, that is, betting odds of 4 to 1, then booking entity 104 make a donation to affinity entity 106.

Booking entity 104 can define the predetermined winning odds threshold to attract or otherwise incent wagerer 102A to place the wager in that wagerer 102A will be incented by a commitment by booking entity 104 to make a donation to one or more affinity entities 106 that will be, or that have already been, selected by wagerer 102A. Such an incentive may assist charities and other philanthropy ventures having interests in common with wagerer 102A. By way of example, and not by way of limitation, each of the one or more affinity entities 106 may be: (i) a charity and other philanthropy venture in or near the community where wagerer 102A resides; (ii) a food bank in or near the community where wagerer 102A resides; (iii) a homeless shelter in or near the community where wagerer 102A resides; (iv) a healthcare provider in or near the community where wagerer 102A resides; (v) a youth sports booster organization in or near the community where wagerer 102A resides; (vi) a faith community organization attended by, or granting membership to, wagerer 102A; (vii) an entrepreneurial advice and consultation organization that assists in the startup of ventures in or near the community where wagerer 102A resides; (viii) etc.

The predetermined winning odds threshold might be defined by booking entity 104 so as to best or better incent wagerer 102A to place a wager. By way of example, and not by way of limitation, predetermined winning odds threshold might be defined by booking entity 104 such that: (i) all winning wagers will commit booking entity 104 to make a defined donation to affinity entity 106; (ii) a majority of the winning wagers will commit booking entity 104 to make a defined donation to affinity entity 106; (iii) only a minority of the winning wagers will commit booking entity 104 to make a defined donation to affinity entity 106; (iv) only wagers exceeding a predetermined minimum wager amount will commit booking entity 104 to make a defined donation to affinity entity 106; (v) the booking entity 104 will be committed to make a defined donation to affinity entity 106 only there is an extremely small, or most unlikely, chance that the wagerer will win the wager; or (vi) some combination of the foregoing.

The time that the betting odds are set by booking entity 104 can vary, depending upon the game or nature of the wager. Some games, like a coin toss or a roulette wheel, do not have changing odds. Also, in the playing of casino games such as video roulette for example, the chances or odds of probability of a winning ball, as set by the software pseudo random number generator, will remain the same throughout the game, regardless of the number of wagerer 102A or the money being bet with booking entity 104. In contrast, sporting events, and financial markets, do not offer the same controlled certainty as some casino games, so the chance (or betting odds) on a given outcome can and do change in the time before the contest or betting event actually starts. In horse racing, football, hockey, etc. the odds are likely to change during the course of betting before each game. So, the time when the possible outcome actually occurs is taken into consideration in disclosed implementations because betting odds change as new bets are received by booking entity 104. This means that probability estimations vary with time. Moreover, the odds set by different booking entities 104 differ from one booking entity 104 to another booking entity. So, disclosed implementations take into consideration the probability of the possible outcome actually occurring as set by booking entity 104 with whom the wager was made by wagerer 102A.

Wagerers data base 110 can include personas information actively provided, or passively acquired if possible, by wagerer 102A. Personas information in wagerers data base 110 can be used by Artificial Intelligent (AI) wagerer incentive generator 130 to generate an incentive most likely to incent wagerer 102 to place a wager with booking entity 104. This AI generated incentive may be a particularly higher donation made to affinity entity 106 when wagerer 102A wins a wager placed with booking entity than donations made by booking entities that compete with affinity entity 106 for wagers by wagerer 102A. AI wagerer incentive generator 130 may generate the incentive by using data accessed, obtained, and/or derived from wagerers database 110, past gaming events database 112, future gaming events database 114, past wagers database 116, future wagers database 118, geographic database 120, affinity entities database 122, affinity entity donations payable database 124, and/or affinity entity donations paid database 126.

Past gaming events database 112 includes information gleaned by booking entity 104 from past gaming events. Future gaming events database 114 includes information gleaned by booking entity 104 from future gaming events. Past wagers database 116 includes information gleaned by booking entity 104 from past wagers placed with booking entity 104 by one or more wagerers 102A. Future wagers database 118 includes information gleaned by booking entity 104 from past wagers placed with booking entity 104 by one or more wagerers 102A for which the result of the game upon which a wager was placed has not yet been determined because the game or wager event has not yet finished or is still ongoing. Geographic database 120 includes geographic addresses of one or more affinity entities in affinity entities database 122, geographic addresses of one or more wagerers 102A in wagerers database 110, and other relevant geographic addresses which can be used to incent wagerer 102A to place a wager with booking entity 104. Affinity entities database 122 includes information gleaned by booking entity 104 for each of one or more affinity entities in affinity entities database 122. Affinity entity donations payable database 124 includes information gleaned by booking entity 104 from gaming events that resulted in a future donation (e.g., a donation that has not yet been made) to be made by booking entity 104 to one or more affinity entities in affinity entities database 122. Affinity entity donations paid database 126 includes information gleaned by booking entity 104 from gaming events that resulted in a donation having been made by booking entity 104 to one or more affinity entities in affinity entities database 122.

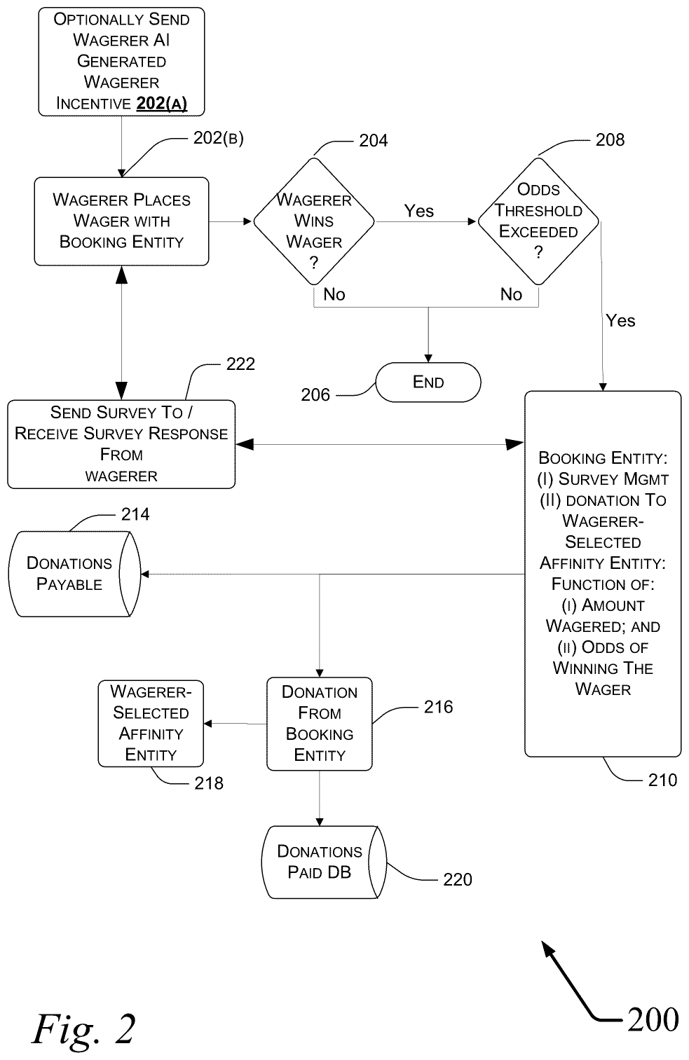

An exemplary process 200 shown in FIG. 2 allows a wagerer to place a bet. At step 202A, an optional step allow the wagerer to be sent an Artificial Intelligence (AI) generated wagerer incentive 102(a) to incent the wagerer to place a bet with a booking entity. By way of example, and not by way of limitation, as shown in FIG. 1, network accessible databases, including wagerers data base 110 which includes personas information provided by wagerer 102A, contain information can be accessed, obtained, and used to make derivations employed by AI wagerer incentive generator 130 to generate an incentive most likely to incent wagerer 102 to place a wager with booking entity 104. This AI generated incentive may be, for instance, a particularly higher donation made to affinity entity 106 when wagerer 102A wins a wager placed with booking entity. AI wagerer incentive generator 130 may generate the incentive by accessing, obtaining, and making derivations using data accessed from wagerers database 110, past gaming events database 112, future gaming events database 114, past wagers database 116, future wagers database 118, geographic database 120, affinity entities database 122, affinity entity donations payable database 124, and/or affinity entity donations paid database 126. The step 218 of Wagerer-Selected Affinity Entity corresponds, by way of example, to network access to one or more of affinity entities database 122, affinity entity donations payable database 124, and affinity entity donations paid database 126

A step 202B of Process 200, the wagerer places a wager with the booking entity. If the wagerer does not win the wager as determined by the query at step 204, the process 200 terminates at step 206. Otherwise, a query is made at step 204 whether the odds threshold of the wagerer winning the wager was exceeded when the wager was won. As previously disclosed herein relative to the “predetermined winning odds”, the odds threshold is defined by the booking entity to incent the wagerer to place a wager. The booking entity can define the predetermined winning odds threshold, or the odds threshold of the wagerer winning the wager, to attract or otherwise incent wagerer to place the wager in that wagerer will be incented by a commitment by booking entity to make a donation to one or more affinity entities that will be, or that have already been, selected by the wagerer. Such an incentive may assist charities and other philanthropy ventures having interests in common with the wagerer. By way of example, and not by way of limitation, each of the one or more affinity entities selected by the wagerer may be: (i) a charity and other philanthropy venture in or near the community where the wagerer resides; (ii) a food bank in or near the community where the wagerer resides; (iii) a homeless shelter in or near the community where the wagerer resides; (iv) a healthcare provider in or near the community where the wagerer resides; (v) a youth sports booster organization in or near the community where the wagerer resides; (vi) a faith community organization attended by, or granting membership to, the wagerer; (vii) an entrepreneurial advice and consultation organization that assists in the startup of ventures in or near the community where the wagerer resides; (viii) etc.

The “predetermined winning odds”, also referred to herein as “the odds threshold” might be defined by the booking entity 104 so as to best or better incent the wagerer to place a wager. By way of example, and not by way of limitation, the odds threshold might be defined by the booking entity such that: (i) all winning wagers will commit the booking entity to make a defined donation to the affinity entity(ies) selected by the wagerer; (ii) a majority of the winning wagers will commit the booking entity to make a defined donation to the affinity entity(ies) selected by the wagerer; (iii) only a minority of the winning wagers will commit the booking entity to make a defined donation to the affinity entity(ies) selected by the wagerer; (iv) only wagers exceeding a predetermined minimum wager amount will commit the booking entity to make a defined donation to the affinity entity(ies) selected by the wagerer; (v) the booking entity will be committed to make a defined donation to the affinity entity(ies) selected by the wagerer only if there is an extremely small, or most unlikely, chance that the wagerer will win the wager; or (vi) some combination of the foregoing.

If the odds threshold, or the predetermined winning odds was exceeded, then process 200 terminates at step 206. Otherwise, process 200 performs steps 210, 216, 218, and 222, where donations payable at step 214 correspond, by way of example, to affinity entity donations payable database 124 seen in FIG. 1, and donations paid at step 220 correspond, by way of example, to affinity entity donations paid database 126 seen in FIG. 1.

At step 222 of process 200, the booking entity may send a survey to the wagerer from whom the booking entity will receive back a survey response. The survey response may include the wagerer's response to various surveyed questions, which questions, for example, ask about the wagerer's experience with the wager process, the degree to which one or more incentives offered by the booking entity to the wagerer incented the wagerer to place the wager, the degree to which the type and kind of donation by the booking entity incented the wagerer to place the wager with the booking entity, what changes might be made to even further incent the wagerer to place future wagers with the booking entity, etc. The survey responses may be inputted into one or more of the network accessible databases, such as are shown in FIG. 1, which responses can be made available for future use by AI Wagerer Incentive Generator 130.

The donation made by the booking entity to the affinity entity(ies) selected by the wagerer will preferably be derived from the amount of the wager and the betting odds at the time when the wager was won by the wager. By way of example, and not by way of limitation, the donation may be larger for larger wagers, and the donation may be larger when the betting odds of the wagerer winning the wager are small as opposed to the betting odds being favorable to the wagerer winning the wager. As such, the wagerer may be incentivized to place the wager, albeit with less than favorable betting odds, because the wagerer is incented to place the wager due to the booking entity's commitment to make a larger donation to the wagerer's selected affinity entity when the betting odds are not favorable to the wagerer.

When the wagerer places a wager on a possible outcome in a game of skill, a game of chance, or a game of a combination of skill and chance, and if the possible outcome actually occurs such that the wagerer wins the bet, and if the possible outcome actually occurred at a time when the probability of the possible outcome actually occurring as set by the booking entity did not exceed a predetermined winning odds threshold, then, as shown at step 210 of process 200, the booking entity makes a donation to an affinity entity selected by the wagerer.

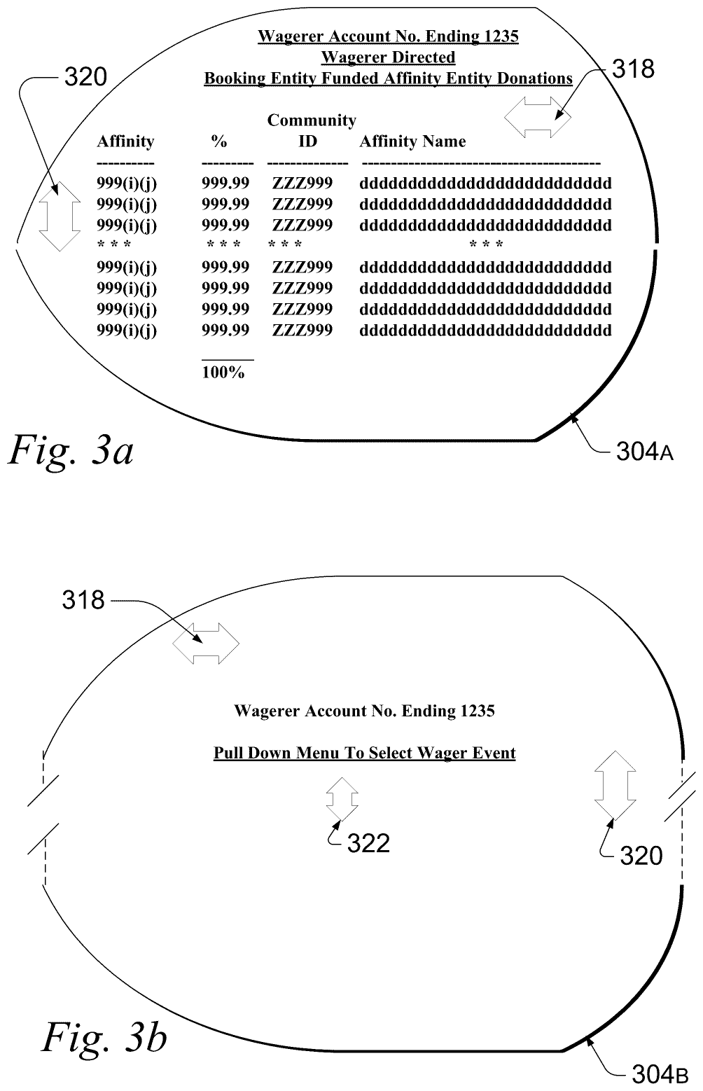

Referring now to FIG. 3a, a screen shot 304A features input and displays fields by which a wagerer has a wagerer account number ending in “12345” by which the wagerer, or agent thereof, can direct a booking entity to make a donation to one or more affinity entities designated by the wagerer, as shown in FIG. 3a, where the booking entity was the entity with whom a wager has been placed by the wagerer. The donation will be made under terms and conditions, under various implementations disclosed herein, as are defined by the booking entity.

The fields provided by screen shot 304A allow the wagerer to specify one or more affinity entities, which may be geographically located in their local community, to which donations are to be made by the booking entity with whom the wagerer places a wager. In such implementations, the booking entity may be given notice of its total periodic donations. Such notice, however, can optionally be given without providing the booking entity with any notice or knowledge as to the specific identity of those affinity entities that are to be the recipients of its donations. The donation mechanism can be set up such that the booking entity makes blind donations, either directly or indirectly, to affinity entities in the local community of the wagerer who selects those local community affinity entities. Accordingly, the donation mechanism may leave direction of the booking entity's donations fully within the discretion of the wagerer, limited only, for example and not limitation, by the restriction that the wagerer can only select from among those affinity entities that serve the local community where the wagerer resides, works, or both, while leaving the actual amount of the booking entity's donation fully within the discretion of the booking entity.

Optionally, a further limitation on those local community affinity entities that may be selected by the wagerer may include control logic that accesses a rating, and/or that derives a rating, for an affinity entity. The control logic may use one or more ratings given by one or more charity rating organizations, where the control logic result is used to determine whether or not the affinity entity is eligible for participation in the implementation as a registered affinity entity that is selectable by wagerers. The ratings may be retrieved via access to one or more network accessible databases where such ratings are input and maintained. Example of charity rating organizations which provide one or more ratings that could be used for various disclosed implementations include a rating database that contains information as to whether a donation to a particular affinity entity can be treated as a tax deduction, Guide Star, Charity Navigator, Give Well, Evangelical Council for Financial Accountability (ECFA), the Better Business Bureau Wise Giving Alliance Standards for Charity Accountability of the Council of Better Business Bureaus, Inc., and the like that now exist or may exist in the further. Moreover, other mechanisms for assessing local community affinity entities may be used to determine whether or not affinity entities are eligible for participation in the disclosed implementations as registered affinity entities that are selectable by wagerers.

Each row in screen shot 304A of FIG. 3a may represent a different Affinity Entity in the local community of the wagerer for which there is a specific code (e.g., 999(i)(j), Community Identifier (e.g., ZZZ999), and Affinity Name as shown in FIG. 3a. A pull down menu of selectable affinity entities (not shown) can be used to provide selectable input to the fields corresponding to affinity entities shown on screen shot 304A.

By way of example, the Affinity Entity and/or the Community ID might identify a specific Affinity Entity that is located in, and provide goods and services to, the borough of Greenwich Village at the southern portion of the geographical island of Manhattan in the city of New York of the State of New York, in the USA. By way of example, and not by way of limitation, the Affinity Entity Code 105(064) (q2e) could have an interpretation where ‘105’ represents the United States of America, the index ‘ 064’ represents the state of New York, “q” represents the City of New York, “2” represents the combined boroughs of Manhattan, and “e” represents the borough of Greenwich Village at the southern portion of the geographical island of Manhattan in the city of New York of the State of New York. The name of the specific Affinity Entity represented the code 105(064) (q2e) can be the Washington Square Food Bank, which may be located in, and philanthropically provide goods and services to, the borough of Greenwich Village at the southern portion of the geographical island of Manhattan in the city of New York of the State of New York, in the USA. Note that the wagerer can use screen shot 304A to specify multiple community IDs each representing a geographic location where the wagerer either has a residence or operates a business in the geographic location or both. Also note that, for each such community ID specified by the wagerer, the second column of the rows of screen shot 304A in FIG. 3a may add up to 100%, thereby providing a percentage of the donation to be made by the booking entity with whom the wagerer placed a wager.

In alternative implementation, the wagerer can select an affinity entity to whom the booking entity is to make a donation, where the affinity entity is a ‘smart contract’ having various wagerer designated terms and conditions. In such implementations, the ‘smart contract’ can be for the donation by the booking entity to be used to make a purchase for a particular good or service, where the donation is facilitated by the smart contract having an Internet computer protocol operating so as to digitally facilitate the performance of the donation according to terms and conditions of the smart contract. The smart contract implementations herein are similar to the smart contact methodologies as disclosed in U.S. patent application Ser. No. 16/466,728, titled “BLOCKCHAIN TRACKING AND MANAGING OF A TRANSACTION INCENTED BY A MERCHANT DONATION TO A CONSUMER AFFINITY”, which is incorporated hereby by reference.

In a further variation, booking entity 104 may select one, some, or all of affinity entity(ies) 103 that are to receive donations from booking entity 104 based upon wagers placed by wagerer 102A (e.g., St. Jude Children's Research Hospital). In yet a further variation, booking entity 104 may require wagerer 102A to select one or more specific affinity entities 106 as some or all of the wagerer 102A's selected affinity entities 106.

In FIGS. 3a-6, reference numerals ending in 18 and 20 represent icons on the respective user interfaces by which a user of the user interface can cause the display on the user interface to be shifted, respectively, horizontally, and vertically to view previously unseen portions of a rendered display.

Referring now to FIG. 3b, screen shot 304B allows a user acting for the wagerer account number ending in 12345 to use a pull down menu to display a list of wager events from which the user can make a selection of a particular wager event.

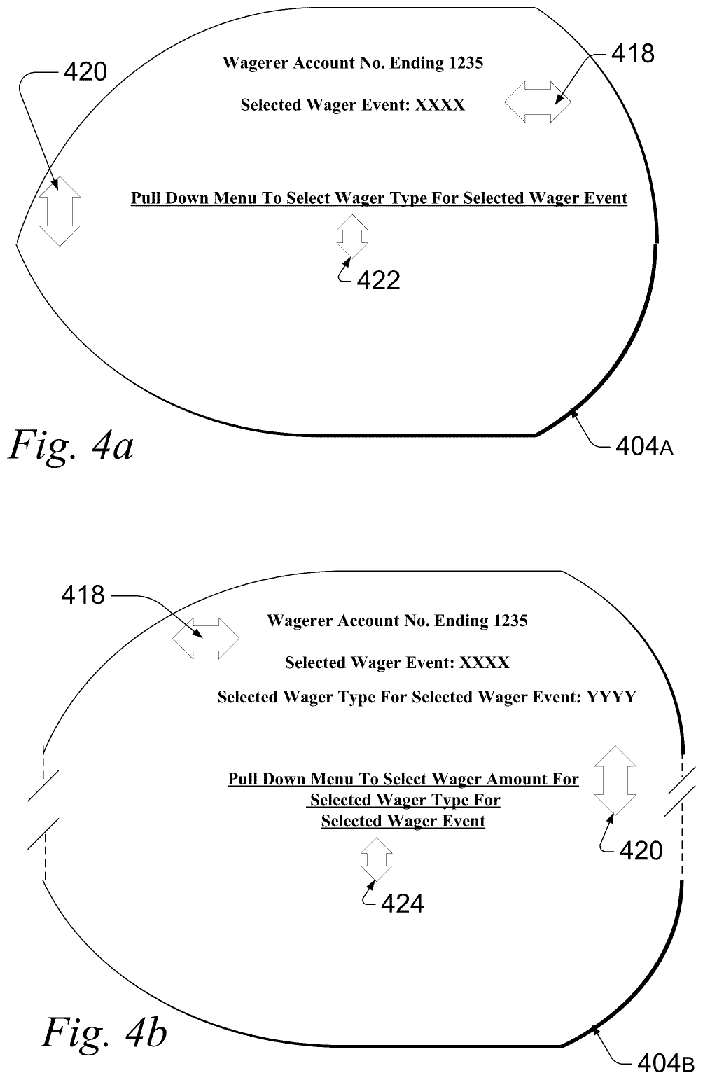

Referring now to FIG. 4a, screen shot 404A allows a user acting for the wagerer account number ending in 12345 to use a pull down menu to display a list of wager types for the wager event selected by use of screenshot 304B in FIG. 3b, and from which the user can make a selection of a particular wager type for the wager event selected by use of screenshot 304B in FIG. 3b wager event.

Referring now to FIG. 4b, screen shot 404B allows a user acting for the wagerer account number ending in 12345 to use a pull down menu to display and select a wager amount from a list of wager amounts for the selected wager type for the selected wager event selected by use of screenshots 304B and 404A in FIGS. 3b and 4a, respectively.

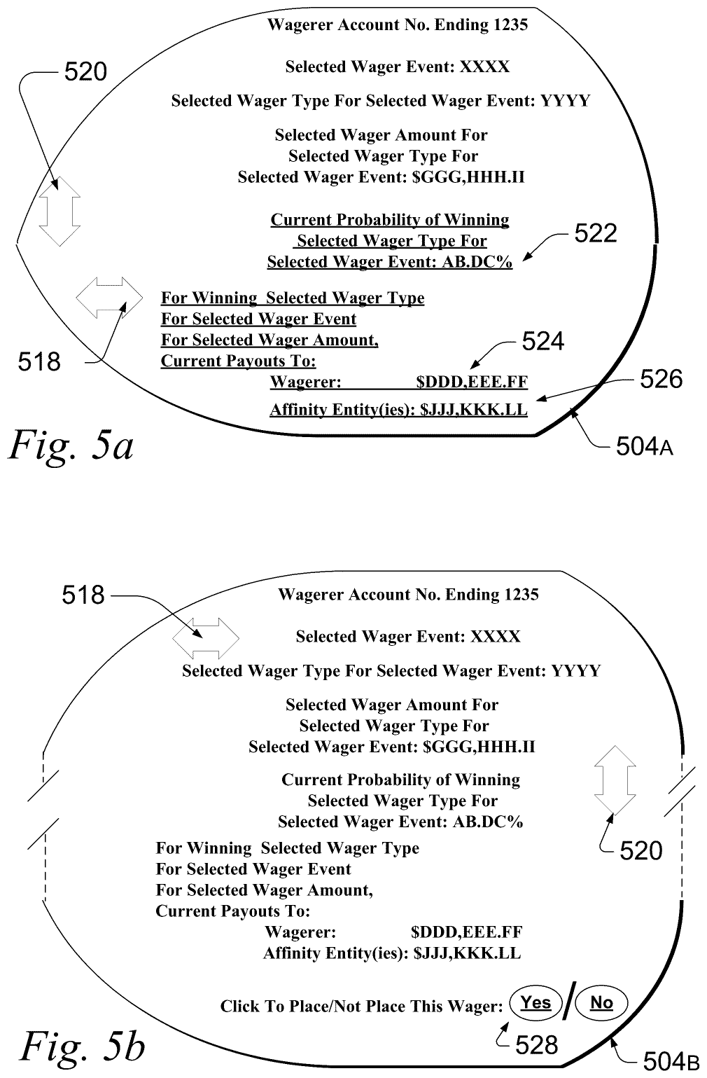

Referring now to FIG. 5a, screen shot 504A allows a user acting for the wagerer account number ending in 12345 to see an offer or incentive from the booking entity to place the wager for the wager amounts for the selected wager type for the selected wager event selected by use of screenshots 304B, 404A, and 404B in FIGS. 3b-5a, respectively. The offer or incentive from the booking entity will include the current probability of winning the selected Wager Type For the Selected Wager Event. As shown in FIG. 5a, the current probability can be a probability expressed as a percentage of a successful outcome of the wager, e.g., AB.DC %. The offer or incentive from the booking entity will also include a commitment from the booking entity if the wagerer wins the wagerer for the selected wager amount for the selected wager type for the selected wager event, where the commitment includes a payout amount, set at the betting odds at the current time, and where the payout is shown for the wagerer, and an amount of a donation by the booking entity to the affinity(ies) that have been, or that will be, selected by the wagerer. Note that, at the time when the wagerer is actually won, the betting odds at that time may be different, which difference may in turn change one or both amounts of the payout and the donation as defined by the booking entity.

Referring now to FIG. 5b, screen shot 504B allows a user acting for the wagerer account number ending in 12345 to click on a “YES” icon and thereby place the wager and thereby receive the commitment from the booking entity as shown in FIG. 5a at screen shot 504A. If, however, the user clicks on a “NO” icon, the wager is not placed and the commitment from the booking entity is not made as shown in FIG. 5a at screen shot 504A. With the placement of the wager, access, retrieval, and updates are made to one or more networks accessible databases 110-122 and with wagerer funds holding financial institution 102c shown in FIG. 1 from which funds for the wagerer's wager are obtained. When the wagerer places a wager, wagerer funds holding financial institution 102c can be adjusted as if a transaction were conducted to fund a wager with a personal payment account of the wagerer, which is any form of payment (e.g., funds derived from a debit or credit account issuer by an issuer to the wagerer). For example, the wagerer, upon placement of the wager, may incur a promissory charging liability that is received by a credit card issuing bank.

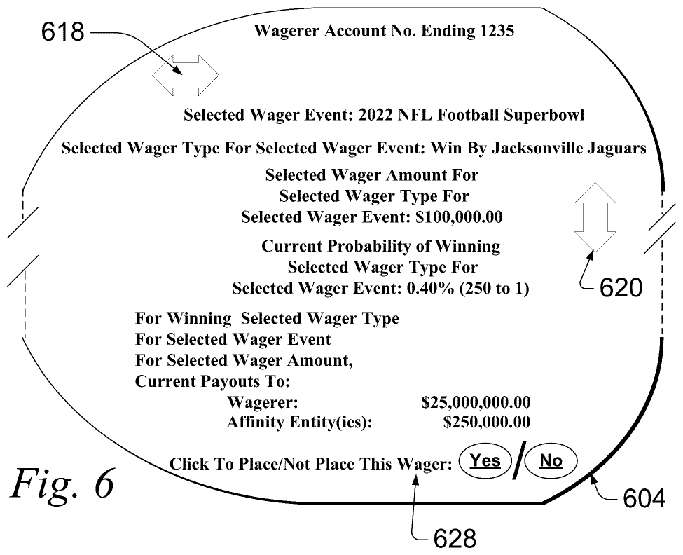

Referring now to FIG. 6, screen shot 604 shows an example of a user acting for the wagerer account number ending in 12345 to see and accept an offer or incentive from a booking entity to place a wager for a wager amount of One Hundred Thousand Dollars ($100,000.00 US) on the 2022 National Football League (NFL) football Superbowl wager event. The wager is placed for the football team Jacksonville Jaguars to be the winner of the 2022 Superbowl in a spread bet wager. The booking entity, at present, has set the spread bet wager for the betting odds to win this wager at four tenths of one percent (0.40%). That is, betting odds of 250-to-1 are presently set against the football team Jacksonville Jaguars to be the winner of the 2022 Superbowl. For these betting odds, the booking entity will payout the wagerer's win at a payout set such that for every one dollar ($1.00) that is bet, there will be a payout of Two Hundred Fifty Dollars ($250 US). As such, if the wagerer places this bet, the booking entity, at least at the present odds, has agreed to payout winnings of Twenty Five Million Dollars ($25,000.000.00 US) to the wagerer. As an additional part of the incentive to place the wager, the booking entity will make a commitment to pay one percent (1%) of the payout as a donation to the affinity entity(ies) selected by the wagerer. As such, the incentive of a donation of Two Hundred Fifty Thousand Dollars ($250,000.00 US) to the affinity entity(ies) selected by the wagerer is presented in the illustrated display screen rendering for the wagerer's consideration. Note that, at the time when the wagerer actually wins the wager, the betting odds at that time may be different than the time at which the “YES” icon is clicked by the user, which difference may in turn change one or both of the payout to the wagerer and the donation by the booking entity to the affinity entity(ies) selected by the wagerer. Preferably, prior to the wagerer placing the wager with the booking entity, the payout and the donation will have predetermined business rules under the control of, that is, defined by, the booking entity, which predetermined business rules are both seen and agreed to by the wagerer.

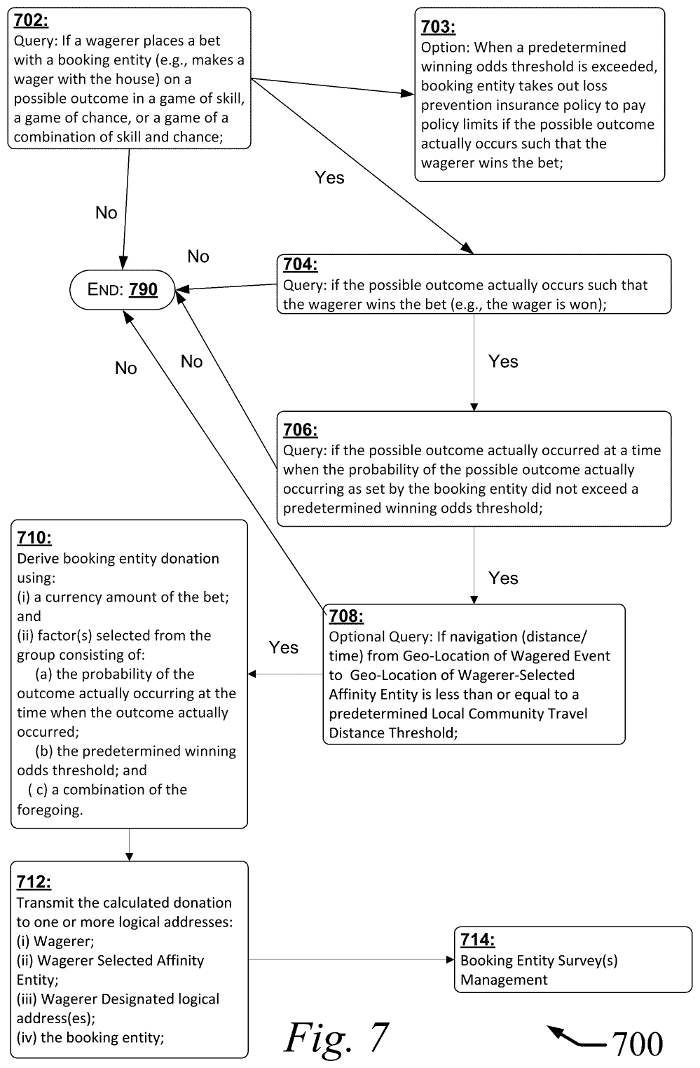

FIGS. 7-11 shown respective processes 700-1100 each of which can be performed in environment 100 of FIG. 1.

In process 700 in FIG. 7, a query is made at step 702 as to whether a wagerer has placed a bet with a booking entity (e.g., makes a wager with the house) on a possible outcome in a game of skill, a game of chance, or a game of a combination of skill and chance. If not then process 700 terminates at step 790. Otherwise, process 700 includes a step 703 for an option, when a predetermined winning odds threshold is exceeded, under which the booking entity takes out loss prevention insurance policy to pay off if the possible outcome actually occurs such that the wagerer wins the bet. Note that the booking entity may opt to take out a loss prevention insurance policy in the unlikely event (low probability or low betting odds) that the wagerer will win a large amount on the wager. This insurance may be desirable in that the betting entity may be obligated to: (i) make bigger donations for bigger odds against the wagerer winning the wager; and/or (ii) make bigger donations for smaller loses (e.g., the wagerer came very close to winning his wager which win was extremely improbable, that is, the odds against the wagerer winning were exceptionally large and for very close losses the booking entity has agreed to make a donation to the wagerer's affinity entity(ies).

In process 700 in FIG. 7, a query is made at step 704 as to whether the possible outcome actually occurs such that the wagerer wins the bet (e.g., the wager is won). If not then process 700 terminates at step 790. Otherwise, process 700 moves to step 706 at which a query is made as to whether the possible outcome actually occurred at a time when the probability of the possible outcome actually occurring as set by the booking entity did not exceed a predetermined winning odds threshold. If not then process 700 terminates at step 790. Otherwise, an optional inquiry is made at step 708 as to whether the navigation (distance/time) from a Geo-Location of the Wagered Event corresponds to the Geo-Location of Wagerer-Selected Affinity Entity. This optional query determines if the distance/time to navigate therebetween is less than or equal to a predetermined Local Community Travel Distance Threshold. This option may be taken if, by way of example and not by way of limitation, the booking entity is willing to make donations for winning wagers only when the affinity entity is located in the same town, community, city, county, state, province, etc. as a geographic location corresponding to the event upon which the wager was placed.

The process conducted at optional step 708 may employ various implementations and variations thereof. For instance a navigation algorithm, using any of various different travel methods (e.g., walking, automobile, bicycle, mass transit, etc.), may be used to determine whether the time, using one or more travel methods, is within a predetermined time limit to ascertain whether or not the predetermined Local Community Travel Distance Threshold has been satisfied (e.g., the donation by the booking entity is to be made to an affinity entity close to the geographic location corresponding to the event upon which the wager was placed.)

By way of example, the affinity entity selected by the wagerer might be determined to be within the same local community if the automobile drive time, as determined from one or more databases of contemporary cartographic road system information, to navigate to the affinity entity is less than a predetermined time threshold (e.g., 17 minutes).

A further alternative implementation may identify the population density of the geographic location corresponding to the event upon which the wager was placed. If the population density exceeds a predetermined density, then the affinity entity selected by the wagerer might be determined to be within the same local community if the time to walk, bicycle or take public transportation to the affinity entity from the geographic location corresponding to the event upon which the wager was placed, as determined from one or more databases of contemporary topographic, mass transit, and/or pedestrian cartographic system information, is less than a predetermined time threshold (e.g., 55 minutes).

Still another such comparison can be whether the geographic location corresponding to the event upon which the wager was placed and that of the selected affinity entity are proximate according to voting, electoral, or political districts. The district use can be determined by an official method, an unofficial method, or a combination of method. By way of example, measurements known within the political gerrymander sciences can be used, including but not limited to a minimum district to convex polygon ratio, shortest split line algorithm, minimum isoperimetric quotient, etc.

The local community corresponding to the geographic location corresponding to the event upon which the wager was placed and that of each of one or more wagerer selected affinities, and separations there between (if any), can be determined from any combination of linear distance, mode-specific navigational transportation travel time, political separation, postal designation, and/or hybrid algorithm that takes into considers geographic barrier features such as rivers, cliffs, and highways, cultural features such as boundaries of identified people groups (e.g., tribes, first nation people, etc.), land ownership such as subdivisions, housing projects, cooperatives, planned communities, military installations, governmental owns and leased properties, etc. Given the foregoing, determinations might be made that the geographic location of the affinity entity(ies) selected by the wagerer are acceptable to the booking entity sufficient to make the donation offered as an incentive to the wager.

Similar or different techniques may be used to determine the respective local community of the geographic location corresponding to the event upon which the wager was placed and that of each of one or more wagerer selected affinities to determine there is a shared local community to whom the booking entity will make a donation.

If the local community of the geographic location corresponding to the event upon which the wager was placed and that of each of one or more wagerer selected affinities are determined to be the same, then the business rule selected by the booking entity may determine the amount of the donation that the booking entity will make to the affinity entity selected the wagerer. In some implementations, the affinity entity to whom the booking entity is to make a donation may only be selected by the wagerer and not be the booking entity. In such implementations, tensions between the goals or purpose of an affinity entity, if any, between the booking entity and the wagerer may be reduced by allowing the identity of the affinity entity to be unknown to the booking entity while being selected by the wagerer. As such, the booking entity may need not be told or be given any notice, directly or indirectly, as to the identity of the affinity, entity selected the wagerer with whom the booking entity has placed a wager. Rather, the booking entity may be told or be given notice to make the required donation as a single payment of, or period payments to, to a single affinity entity that may thereafter make respective disbursements for the booking entity accordingly to those affinity entities that had been selected by those wagerers with whom the wagerers had placed bets with the booking entities. A booking entity who, by force of reason or conscience, does not want to make a donation to a particular affinity entity need not do so directly, as any and all booking entity donations are made blindly through the single affinity entity that make all disbursements to all affinity entities. Accordingly, each booking entity may have notice of its total periodic donations without knowing the identity of the intended recipients, thereby leaving direction of donations fully within the discretion of the wagerers who place wagers with the booking entity, limited only by an optional restriction that the booking entity's donation must be made to an affinity entity serving the local community of the geographic location corresponding to the event upon which the wager was placed.

In process 700 in FIG. 7, step 710 a donation to be made by the booking entity is derived using: (i) a currency amount of the bet; and (ii) factor(s) selected from the group consisting of (a) the probability of the outcome actually occurring at the time when the outcome actually occurred (e.g., the wager is won).; (b) the predetermined winning odds threshold; and (c) a combination of the foregoing.

In process 700 in FIG. 7, step 712 the donation to be made by the booking entity is transmitted to one or more logical addresses: (i) Wagerer; (ii) Wagerer Selected Affinity Entity; (iii) Wagerer Designated logical address(es); (iv) the booking entity. In such cases, the wagerer may wish that a notice be sent to supporters, friends, and/or allies of the selected affinity entity as to the forthcoming donation such that the wagerer will provide the logical address(es) for such purposes. For example, text messages, social media posts, URL website additions, instant messaging transmissions, facsimiles, online newspaper releases, and/or emails can be sent.

In process 700 in FIG. 7, step 714 the booking entity may send and receive back responses from the wagerer for a survey for uses as described elsewhere herein.

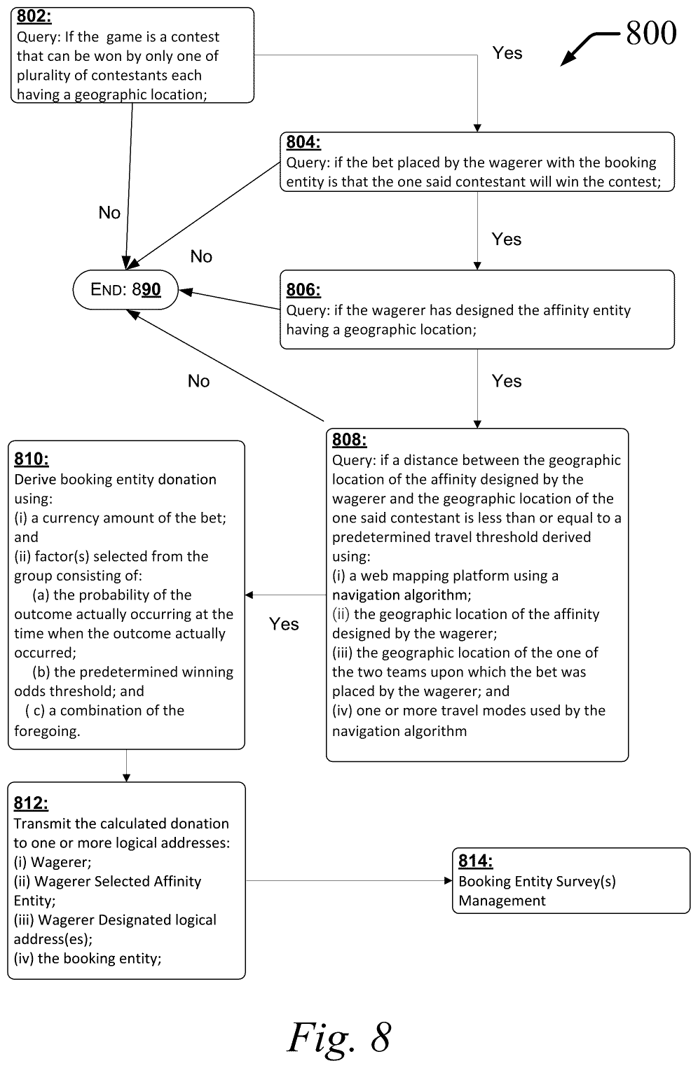

Process 800 in FIG. 8 may follow and/or be incorporated with process 700 of FIG. 7, where a query is made at step 802 as to whether the game is a contest that can be won by only one of plurality of contestants each having a geographic location. If not then process 800 terminates at step 890. Otherwise, process 800 moves to step 804 at which a determination is made as to whether the bet placed by the wagerer with the booking entity is that the one contestant will win the contest. If not then process 800 terminates at step 890. Otherwise, process 800 moves to step 806 at which a determination is made as to whether the wagerer has designed the affinity entity having a geographic location. If not then process 800 terminates at step 890. Otherwise, process 800 moves to step 808 at which a determination is made as to whether a distance between the geographic location of the affinity designed by the wagerer and the geographic location of the one contestant is less than or equal to a predetermined travel threshold derived using: (i) a web mapping platform using a navigation algorithm; (ii) the geographic location of the affinity designed by the wagerer; (iii) the geographic location of the one of the two teams upon which the bet was placed by the wagerer; and (iv) one or more travel modes used by the navigation algorithm. Implementation of step 806, in numerous variations thereof, is disclosed and described elsewhere herein. If not then process 800 terminates at step 890. Otherwise, process 800 moves to step 810 at which a donation to be made by the booking entity is derived. The derivation for the donation can use: (i) a currency amount of the bet; and (ii) factor(s) including: (a) the probability of the outcome actually occurring at the time when the outcome actually occurred; (b) the predetermined winning odds threshold; and (c) a combination of the foregoing.

After step 810 in process 800 in FIG. 8, step 812 initiates a transmission of the donation to be made by the booking entity to one or more logical addresses: (i) the Wagerer; (ii) the Wagerer Selected Affinity Entity; (iii) the Wagerer Designated logical address(es); (iv) the booking entity. In such cases, the wagerer may wish that a notice be sent to allies of the selected affinity entity as to the forthcoming donation such that the wagerer will provide the logical address(es) for such purposes.

In process 800 in FIG. 8, step 814 the booking entity may send and receive back responses from the wagerer for a survey for uses as described elsewhere herein.

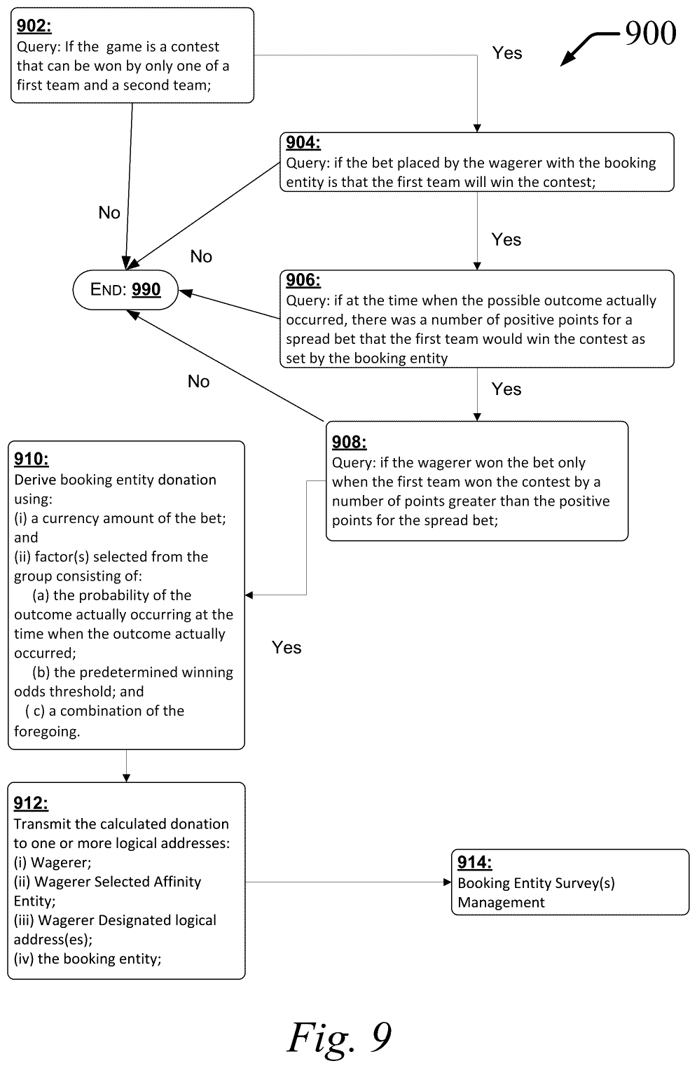

Process 900 in FIG. 9 may follow and/or be incorporated with process 700 of FIG. 7, where a query is made at step 902 as to whether the game is a contest that can be won by only one of a first team and a second team. If not then process 900 terminates at step 990. Otherwise, process 900 moves to step 904 at which a determination is made as to whether the bet placed by the wagerer with the booking entity is that the first team will win the contest. If not then process 900 terminates at step 990. Otherwise, process 900 moves to step 906 at which a determination is made as to whether, if at the time when the possible outcome actually occurred, there was a number of positive points for a spread bet that the first team would win the contest as set by the booking entity. If not then process 900 terminates at step 990. Otherwise, process 900 moves to step 908 at which a determination is made as to whether the wagerer won the bet only when the first team won the contest by a number of points greater than the positive points for the spread bet. If not then process 900 terminates at step 990. Otherwise, process 900 moves to step 910 at which at which a donation to be made by the booking entity is derived. The derivation for the donation can use: (i) a currency amount of the bet; and (ii) factor(s) selected from: (a) the probability of the outcome actually occurring at the time when the outcome actually occurred; (b) the predetermined winning odds threshold; and (c) a combination of the foregoing.

After step 910 in process 900 in FIG. 9, step 912 initiates a transmission of the donation to be made by the booking entity to one or more logical addresses: (i) the Wagerer; (ii) the Wagerer Selected Affinity Entity; (iii) the Wagerer Designated logical address(es); (iv) the booking entity. In such cases, the wagerer may wish that a notice be sent to allies of the selected affinity entity as to the forthcoming donation such that the wagerer will provide the logical address(es) for such purposes as discussed elsewhere herein.

In process 900 in FIG. 9, step 914 the booking entity may send and receive back responses from the wagerer for a survey for uses as described elsewhere herein.

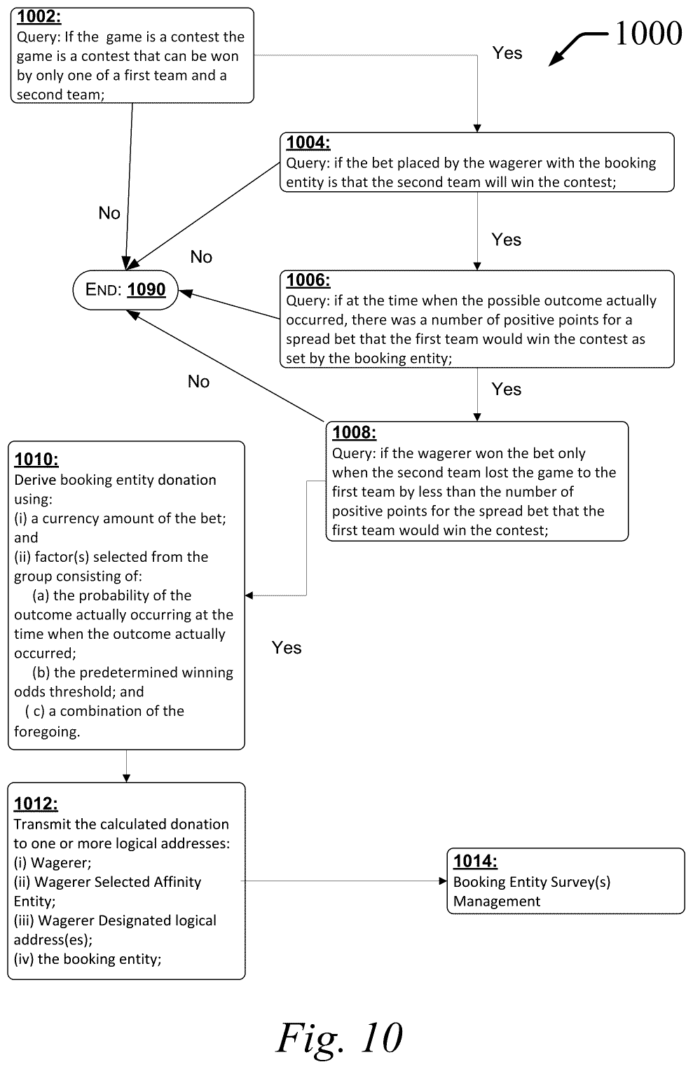

Process 1000 in FIG. 10 may follow and/or be incorporated with process 700 of FIG. 7, where a query is made at step 1002 as to whether the game is a contest that can be won by only one of a first team and a second team. If not then process 1000 terminates at step 1090. Otherwise, process 1000 moves to step 1004 at which a determination is made as to whether the bet placed by the wagerer with the booking entity is that the second team will win the contest. If not then process 1000 terminates at step 1090. Otherwise, process 1000 moves to step 1006 at which a determination is made as to whether, if at the time when the possible outcome actually occurred, there was a number of positive points for a spread bet that the first team would win the contest as set by the booking entity. If not then process 1000 terminates at step 1090. Otherwise, process 1000 moves to step 1008 at which a determination is made as to whether the wagerer won the bet only when the second team lost the game to the first team by less than the number of positive points for the spread bet that the first team would win the game. If not then process 900 terminates at step 1090. Otherwise, process 1000 moves to step 1010 at which at which a donation to be made by the booking entity is derived. The derivation for the donation can use: (i) a currency amount of the bet; and (ii) factor(s) selected from: (a) the probability of the outcome actually occurring at the time when the outcome actually occurred; (b) the predetermined winning odds threshold; and (c) a combination of the foregoing.

After step 1010 in process 1000 in FIG. 10, step 1012 initiates a transmission of the donation to be made by the booking entity to one or more logical addresses: (i) the Wagerer; (ii) the Wagerer Selected Affinity Entity; (iii) the Wagerer Designated logical address(es); (iv) the booking entity. In such cases, the wagerer may wish that a notice be sent to allies of the selected affinity entity as to the forthcoming donation such that the wagerer will provide the logical address(es) for such purposes as discussed elsewhere herein.

In process 1000 in FIG. 10, step 1014 the booking entity may send and receive back responses from the wagerer for a survey for uses as described elsewhere herein.

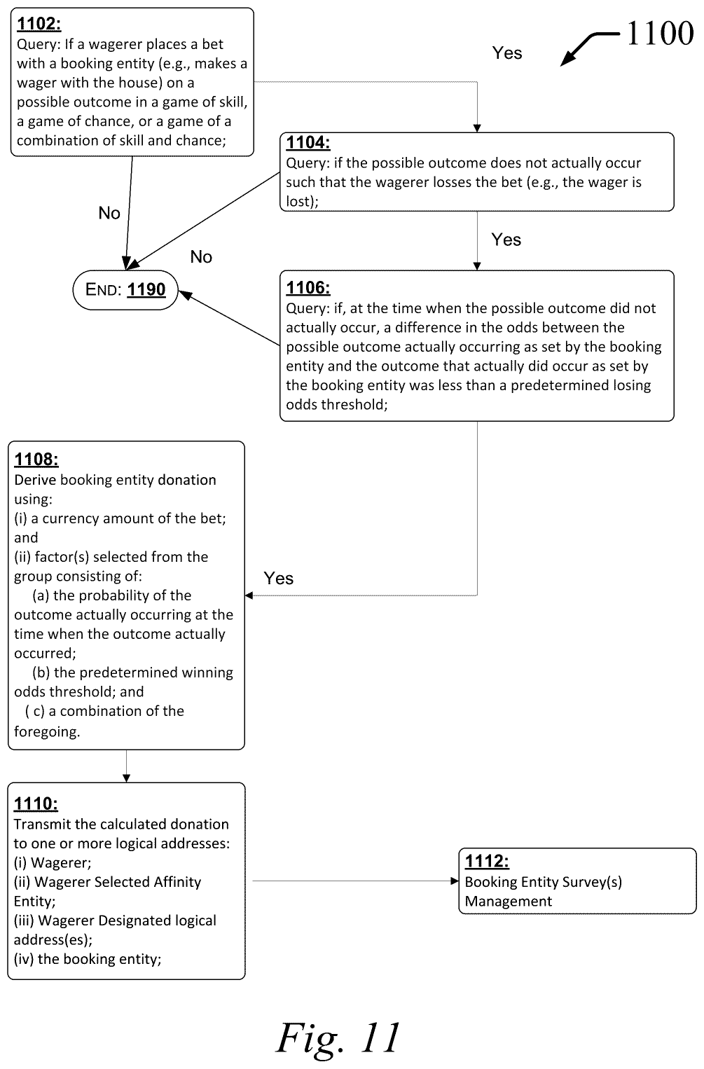

In process 1100 in FIG. 11, a query is made at step 1102 as to whether a wagerer has placed a bet with a booking entity (e.g., makes a wager with the house) on a possible outcome in a game of skill, a game of chance, or a game of a combination of skill and chance. If not then process 1100 terminates at step 1190. Otherwise, process 1100 moves to step 1004 at which a determination is made as to whether the possible outcome does not actually occur such that the wagerer losses the bet (e.g., the wager is lost). If not then process 1100 terminates at step 1190. Otherwise, process 1100 moves to step 1106 at which a determination is made as to whether, at the time when the possible outcome did not actually occur, a difference in the odds between the possible outcome actually occurring as set by the booking entity and the outcome that actually did occur as set by the booking entity was less than a predetermined losing odds threshold. If not then process 1100 terminates at step 1190. Otherwise, process 1100 moves to step 1108 at which a donation to be made by the booking entity is derived. The derivation for the donation can use: (i) a currency amount of the bet; and (ii) factor(s) selected from: (a) the probability of the outcome actually occurring at the time when the outcome actually occurred; (b) the predetermined winning odds threshold; and (c) a combination of the foregoing.

After step 1110 in process 1100 in FIG. 11, step 1112 initiates a transmission of the donation to be made by the booking entity to one or more logical addresses: (i) the Wagerer; (ii) the Wagerer Selected Affinity Entity; (iii) the Wagerer Designated logical address(es); (iv) the booking entity. In such cases, the wagerer may wish that a notice be sent to allies of the selected affinity entity as to the forthcoming donation such that the wagerer will provide the logical address(es) for such purposes as are also described elsewhere herein.

In process 1100 in FIG. 11, step 1114 the booking entity may send and receive back responses from the wagerer for a survey for uses as described elsewhere herein.

One purpose of step 1106 of process 1100 in FIG. 11 is to provide a wagerer with a particular type of incentive to make a wager with a booking entity. In this particular type of incentive, the odds of winning the wager are substantially improbable, where the wager is lost at the time of the corresponding wager event, but where the loss of the wager was substantially improbably because the loss was by a substantially improbably small margin.

By way of illustration, and not by way of limitation, of step 1106, a booking entity may set a point spread bet on a wager on the margin of victory in a sporting event, for instance a football or basketball game. Where one team in the specific sporting event is favored to win, then that team must win the game by a certain number of points and that teams is so designated by a minus sign next to that team's margin in the point spread bet. The other team is the underdog, which team can lose within a certain margin, or win the game outright, to win the wager. The underdog will be designated with a plus sign in the point spread bet that is set by the booking entity. If Team-A is playing Team-B in the specific sporting event, and the point spread bet for Team-A is −250, this means that Team-A is favored to win the specific sporting event by 250 points. The favorite team is understood by a wagerer to be Team-A because of the designation of the minus sign which mean that Team-A is favored and therefore perceived to be more likely to win the competition. As such, Team-A needs to win by 250 points or more for the wagerer to win the wager. If the point spread for Team-B is +249.5, then Team-B needs to either lose by 1-249 points, or win the game, to cover the spread and for the wagerer win the bet. The plus signs indicates that Team-B is not the team that is favored to win the competition (e.g., the underdog team). If the point spread bet is a whole number (e.g., Team B+250), and Team-A wins by exactly by that whole number (Team-A wins by exactly 250 points), then the booking entity will refund to the wager the wagered amount on the wager. Given the above point spread bet illustration, as example of step 1106 of process 1100 in FIG. 11, a determination is made as to whether, at the time when the possible outcome did not actually occur, a difference in the odds between the possible outcome actually occurring as set by the booking entity and the outcome that actually did occur as set by the booking entity was less than a predetermined losing odds threshold. In this case, as an incentive from the booking entity to the wagerer to place the bet, the predetermined losing odds threshold might be set by the booking entity such that the booking entity will make a donation if Team-B losses by two percent (2%) or less of the point spread bet for Team-A which is currently set by the booking entity at −250. So, the booking entity will make the donation if Team-B loses the competition with Team-A by less than five (5) points. Note, however, that the incentive from the booking entity to the wagerer to place the bet might be further conditioned by the booking entity such that the booking entity will make a donation only if the amount of the wager exceeds a predetermined minimum wager. By way of example, and not by way of limitation, the booking entity might define the conditions under which the donation will be made to include both: (i) Team-B losing by two percent (2%) or less of the point spread bet; and (ii) the amount of the wager that is wagered by the wagerer must be at least Five Hundred Dollars ($500.00 US).

The implementations of the systems and methods described herein above may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example, and without limitation, the various programmable computers may be a server, network appliance, set-top box, embedded device, computer expansion module, personal computer, laptop, personal data assistant, cellular telephone, smartphone device, UMPC tablets and wireless hypermedia device or any other computing device capable of being configured to carry out the methods described herein.

Program code is applied to input data to perform the functions described herein and to generate output information. The output information is applied to one or more output devices, in known fashion. In some embodiments, the communication interface may be a network communication interface. In embodiments in which elements of the invention are combined, the communication interface may be a software communication interface, such as those for inter-process communication. In still other embodiments, there may be a combination of communication interfaces implemented as hardware, software, and combination thereof.

Each program may be implemented in a high level procedural or object oriented programming or scripting language, or a combination thereof, to communicate with a computer system. However, alternatively the programs may be implemented in assembly or machine language, if desired. The language may be a compiled or interpreted language. Each such computer program may be stored on a storage media or a device (e.g., ROM, magnetic disk, optical disc), readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the systems and methods of the described embodiments are capable of being distributed in a computer program product including a physical, non-transitory computer readable medium that bears computer usable instructions for one or more processors. The medium may be provided in various forms, including one or more diskettes, compact disks, tapes, chips, magnetic and electronic storage media, volatile memory, non-volatile memory and the like. Non-transitory computer-readable media may include all computer-readable media, with the exception being a transitory, propagating signal. The term non-transitory is not intended to exclude computer readable media such as primary memory, volatile memory, RAM and so on, where the data stored thereon may only be temporarily stored. The computer usable instructions may also be in various forms, including compiled and non-compiled code.

Throughout the following discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions. One should further appreciate the disclosed computer-based algorithms, processes, methods, or other types of instruction sets can be embodied as a computer program product comprising a non-transitory, tangible computer readable media storing the instructions that cause a processor to execute the disclosed steps. One should appreciate that the systems and methods described herein may involve the execution of transaction and transfer of value between merchants and consumers to provide economic and commercial benefits. One should appreciate that the systems and methods described herein may involve particular configuration of computer hardware components to provide incentives to consumers and transfer value between consumers, merchants, card issuers, and affinity entities. One should appreciate that the systems and methods described herein may involve an interconnected network of computer hardware for transferring electronic data signals and executing transactions.

The above discussion provides many example implementation of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In at least some implementations, the system may include one or more processors (e.g., digital signal processors, microprocessors, etc.), each being adapted to execute instructions to perform at least some of the methods, operations, and processes described herein with respect to the figures. Such instructions may be stored or held in storage media as instructions.

The methodologies described herein may be implemented in different ways and with different configurations depending upon the particular application. For example, such methodologies may be implemented in hardware, firmware, and/or combinations thereof, along with software. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

By way of example, the web enabled mobile device 102B seen in FIG. 1 communicates with a network via data transmission carrier 108. Such access may be programmed using server-client coding methodologies, an application executing on the former can be a thin client mobile web browser or an application specific to perform implementations described herein. Such a specific application can be coded to execute on a mobile device running an open-source operating system. For example, the Tizen operating system can be used as the operating system for the mobile device 102B seen in FIG. 1, which can be a smartphone, a tablet, an in-vehicle infotainment (IVI) device controller or “headunit”, or other web enabled mobile computing device.

Alternatively, wagerer 102A may utilize submit a wagerer loyalty identity card to a card reader/scanner 102C in person when wagerer 102A is physically present at a brick and mortar location operated by the booking entity 104 (e.g., a casino). The card reader/scanner 102C is connected with the Wagerers DB 110 to authenticate wagerer 102A, receive information from, and/or update information on the wagerer loyalty identity card. The reading/scanning of the wagerer 102A/s wagerer loyalty identity card starts a new in-person, physically present, session where donations by the booking entity 104 can be generated, as described herein, based on the wagers placed by the wagerer 102A. (e.g., sports betting in a lounge physically located in the casino, playing slot machines physically located in the casino, playing table games such as roulette or poker that are physically situated in the casino.)

Any networked computing device depicted in environment 100 seen in FIG. 1 may reside on including a processor and memory, such as a personal computer, workstation, server, portable computer, mobile device, personal digital assistant, laptop, tablet, smart phone, WAP phone, an interactive television, video display terminals, gaming consoles, electronic reading device, and portable electronic devices or a combination of these. Each networked computing device may include one or more microprocessors that may be any type of processor, such as, for example, any type of general-purpose microprocessor or microcontroller, a digital signal processing (DSP) processor, an integrated circuit, a programmable read-only memory (PROM), or any combination thereof. One or more of the networked computing devices may include any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), or the like. One or more of the networked computing devices may include one or more input devices, such as a keyboard, mouse, camera, touch screen and a microphone, and may also include one or more output devices such as a display screen and a speaker. One or more of the networked computing devices may include a network interface in order to communicate with other components, to serve an application and other applications, and perform other computing applications by connecting to network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these. Although only one loyalty system 20 is shown for clarity, there may be multiple loyalty systems 26 or groups of loyalty systems 26 distributed over a wide geographic area and connected via e.g. network. One or more of the networked computing devices may include may be connected to the Internet or other network in order to interact and connect with one or more booking entities 104, one or more wagerer funds holding financial institutions 102C, one or more affinity entities 1066.

The herein described databases for storage media may comprise primary, secondary, and/or tertiary storage media. Primary storage media may include memory such as random access memory and/or read-only memory, for example. Secondary storage media may include a mass storage such as a magnetic or solid-state hard drive. Tertiary storage media may include removable storage media such as a magnetic or optical disk, a magnetic tape, a solid-state storage device, etc. In certain implementations, the storage media or portions thereof may be operatively receptive of, or otherwise configurable to couple to, other components of a computing platform, such as a processor. Network accessible databases shown in FIG. 1 may provide a persistent store for other databases described herein.

In at least some implementations, one or more portions of the herein described storage media may store signals representative of data and/or information as expressed by a particular state of the storage media. For example, an electronic signal representative of data and/or information may be “stored” in a portion of the storage media (e.g., memory) by affecting or changing the state of such portions of the storage media to represent data and/or information as binary information (e.g., ones and zeros). As such, in a particular implementation, such a change of state of the portion of the storage media to store a signal representative of data and/or information constitutes a transformation of storage media to a different state or thing.

Some portions of the preceding detailed description have been presented in terms of algorithms or symbolic representations of operations on binary digital electronic signals stored within a memory of a specific apparatus or special purpose computing device or platform. In the context of this particular specification, the term specific apparatus or the like includes a general-purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated as electronic signals representing information. It has proven convenient at times, principally for reasons of common usage, to refer to such signals as bits, data, values, elements, symbols, characters, terms, numbers, numerals, information, or the like. It should be understood, however, that all of these or similar terms are to be associated with appropriate physical quantities and are merely convenient labels.

Unless specifically stated otherwise, as apparent from the following discussion, it is appreciated that throughout this specification discussions utilizing terms such as “processing,” “computing,” “calculating,”, “identifying”, “determining”, “establishing”, “obtaining”, and/or the like refer to tangible actions or processes of a specific apparatus, such as a special purpose computer or a similar special purpose electronic computing device that generate discernible results. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device. In the context of this particular patent application, the term “specific apparatus” may include a general-purpose computer once it is programmed to perform particular functions pursuant to instructions from program software.

Reference throughout this specification to “one example”, “an example”, “certain examples”, or “exemplary implementation” means that a particular feature, structure, or characteristic described in connection with the feature and/or example may be included in at least one feature and/or example of claimed subject matter. Thus, the appearances of the phrase “in one example”, “an example”, “in certain examples” or “in some implementations” or other like phrases in various places throughout this specification are not necessarily all referring to the same feature, example, and/or limitation. Furthermore, the particular features, structures, or characteristics may be combined in one or more examples and/or features.

While there has been illustrated and described what are presently considered to be example features, various other modifications may be made, and equivalents may be substituted, without departing from claimed subject matter. Additionally, many modifications may be made to adapt a particular situation to the teachings of claimed subject matter without departing from the central concept described herein. Therefore, embodiments may not be limited to the particular examples disclosed, but may also include all aspects falling within the scope of appended claims, and equivalents thereof.

The various steps or acts in a method or process may be performed in the order shown, or may be performed in another order. Additionally, one or more process or method steps may be omitted or one or more process or method steps may be added to the method and processes. An additional step, block, or action may be added in the beginning, end, or intervening existing elements of the methods and processes. Based on the disclosure and teachings provided herein, a person of ordinary skill in the art will appreciate other ways and/or methods for various implements. Moreover, it is understood that a functional step of described methods or processes, and combinations thereof can be implemented by computer program instructions that, when executed by a processor, create means for implementing the functional steps. The instructions may be included in non-transitory computer readable medium that can be loaded onto a general-purpose computer, a special purpose computer, or other programmable apparatus.

In the preceding detailed description, numerous specific details have been set forth to provide a thorough understanding of embodiments described herein. However, some embodiments may be practiced without these specific details. In other instances, methods and systems that would be known by one of ordinary skill have not been described in detail so as not to obscure claimed subject matter.

What is claimed is:

1. A method comprising:
receiving from a wagerer:
an identification of an affinity entity; and
a wager placed by the wagerer on a possible outcome of a game;
when:
the possible outcome of the game actually occurs in the game such that the wagerer wins the wager;
and
the possible outcome of the game actually occurs at a time in the game when the probability of the possible outcome occurring during the game did not exceed a predetermined winning odds threshold;
then:
crediting a donation of an amount to an account corresponding to the affinity entity, wherein the amount of the donation is derived using:
a currency amount of the wager;
and
a factor selected from the group consisting of:
the probability of the outcome actually occurring at the time when the outcome actually occurred (bigger odds against winning, larger donations for a win);
the predetermined winning odds threshold (donations only for wins against high odds);
and
a combination of the foregoing.

2. The method as defined in claim 1, wherein:
the game is a contest that can be won by only one of plurality of contestants each having a geographic location;
the wager placed by the wagerer is that the one said contestant will win the contest;
the affinity entity has a geographic location;
the one said contestant who wins the contest has a geographic location;
and
the donation to the affinity entity is credited only when a distance between the geographic location of the affinity and a geographic location of the one said contestant who wins the contest does not exceed a predetermined travel threshold.

3. The method as defined in claim 2, wherein:
the contest that can be won by only one of a first team and a second team;
the wager placed by the wagerer is that the second team will win the contest;
at the time when the possible outcome actually occurred, there was a number of positive points for a spread bet that the first team would win the contest as set by the booking entity;
and
the wagerer won the wager only when the second team lost the contest to the first team by less than the number of positive points for the spread bet that the first team would win the contest.

4. The method as defined in claim 2, wherein the predetermined travel threshold is derived using:
a web mapping platform using an online navigation algorithm; and
one or more travel modes used by the navigation algorithm.

5. The method as defined in claim 1, wherein the wager is received by a booking entity;

6. The method as defined in claim 5, wherein the time that the probability of the possible outcome occurs is set by the booking entity.

7. The method as defined in claim 5, wherein the probability of the possible outcome occurs during the game is set by the booking entity.

8. The method as defined in claim 5, wherein the donation of the amount to the account corresponding to the affinity entity is debited to an account corresponding to the booking entity.

9. The method as defined in claim 1, wherein the game is of a game type selected from the group consisting of:
a game of skill;
a game of chance; and
a game of a combination of skill and chance.

10. The method as defined in claim 1, wherein the probability of the outcome actually occurring at the time during the game results in:
a larger said donation when said probability of the outcome actually occurring at the time during the game is larger; and
a smaller said donation when said probability of the outcome actually occurring at the time during the game is smaller

11. The method as defined in claim 1, wherein the amount of the donation is proportional to the probability of the outcome actually occurring at the time.

12. A non-transitory, computer readable medium or media having stored thereon computer-interpretable instructions which when executed by hardware performs the method defined in claim 1.

13. A method comprising:
receiving from a wagerer:
an identification of an affinity entity; and
a wager placed by the wagerer on a possible outcome of a game;
when:
the possible outcome of the game did not actually occur in the game such that the wagerer loses the wager;
and
at the time when the possible outcome did not actually occur, an odds difference in:
the probability of the possible outcome actually occurring; and
the probability of the possible outcome of the game not actually occurring in the game is less than a predetermined losing odds threshold;
then:
crediting a donation of an amount to an account corresponding to the affinity entity, wherein the amount of the donation is derived using:
a currency amount of the wager;
and
the odds difference.

14. The method as defined in claim 13, wherein:
the wager is received by a booking entity
the time that the probability of the possible outcome occurs is se by the booking entity;
the probability of the possible outcome occurs during the game is set 1w the booking entity;
the donation of the amount to the account corresponding to the affinity entity is debited to an account corresponding to the booking entity; and

15. The method as defined in claim 13, wherein the game is of a game type selected from the group consisting of:
a game of skill;
a game of chance; and
a game of a combination of skill and chance.

16. The method as defined in claim 13, wherein the amount of the donation is proportional to the probability of the possible outcome of the game not actually occurring in the game.

17. A non-transitory, computer readable medium or media having stored thereon computer-interpretable instructions which when executed by hardware performs the method defined in claim 13.

18. A method comprising:
receiving from a wagerer:
an identification of an affinity entity; and
a wager placed by the wagerer on a possible outcome of a game, wherein:
the game is a contest that can be won by only one of plurality of contestants each having a geographic location;
the wager placed by the wagerer is that the one said contestant will win the contest;
the affinity entity has a geographic location;
the one said contestant who wins the contest has a geographic location;
the contest can be won by only one of a first team and a second team;
the wager placed by the wagerer that the second team will win the contest;
at the time when the possible outcome actually occurred, there was a number of positive points for a spread bet that the first team would win the contest as set by a booking entity;
and
the wagerer is won the wager only when the second team lost the contest to the first team by less than the number of positive points for the spread bet that the first team would win the contest;
and
when:
a distance between the geographic location of the affinity and a geographic location of the one said contestant who wins the contest does not exceed a predetermined travel threshold;
the possible outcome of the game actually occurs in the game such that the wagerer wins the wager;
and
the possible outcome of the game actually occurs at a time in the game when the probability of the possible outcome occurring during the game did not exceed a predetermined winning odds threshold;
then:
crediting a donation of an amount to an account corresponding to the affinity entity, wherein the amount of the donation is derived using:
a currency amount of the wager;
and
a factor selected from the group consisting of:
the probability of the outcome actually occurring at the time when the outcome actually occurred (bigger odds against winning, larger donations for a win);
the predetermined winning odds threshold (donations only for wins against high odds);
and
a combination of the foregoing.

19. The method as defined in claim 18, wherein the game is of a game type selected from the group consisting of:
a game of skill;
a game of chance; and
a game of a combination of skill and chance.

20. A non-transitory, computer readable medium or media having stored thereon computer-interpretable instructions which when executed by hardware performs the method defined in claim 19.
